(19) United States
(12) Patent Application Publication
(10) Pub. No.: US 2021/0025917 A1
(43) Pub. Date: Jan. 28, 2021

(54) METHOD AND SYSTEM FOR EVALUATING THE PATH OF AN OPERATOR ON A SHOP FLOOR

(71) Applicant: COMPAGNIE GENERALE DES ETABLISSEMENTS MICHELIN, Clermont-Ferrand (FR)

(72) Inventors: KEVIN AMETEPE, Clermont-Ferrand (FR); MATTHIEU LUTZ, Clermont-Ferrand (FR)

(21) Appl. No.: 17/043,336

(22) PCT Filed: Mar. 27, 2019
(86) PCT No.: PCT/FR2019/050698

§ 371 Date: Sep. 29, 2020

(30) Foreign Application Priority Data
Mar. 29, 2018 (FR) 18/52717

(51) Int. Cl. G01P 15/08; G01S 5/02

(52) U.S. Cl. CPC G01P 15/0888; G01S 5/0257

(57) ABSTRACT

Disclosed is a method for evaluating the path of an operator equipped with a connected device in an industrial manufacturing workshop. Also disclosed is a system allowing such a method to be implemented.

### FIELD OF THE INVENTION

The present invention relates to the industrial field, and more particularly to the field of the management of production workshops. Within industrial manufacturing factories, operators have to move around, in particular to interact with large machines, some of which are automated, for a certain number of tasks. Among the tasks to be accomplished, mention may in particular be made of the ordinary operation of machines, reaction to chance factors, corrective or maintenance actions, and supplying machines with raw materials.

All of these tasks play a key role in the continuity of production operation, and it would be useful for production managers to be able to assess the movements operators make to carry out these various tasks.

Specifically, the operations and habits behind the movements of operators and their interactions with machines are at the heart of the potential to optimize organization and processes within factories, since the availability rate of a production tool in a factory is highly dependent on the processes implemented with respect to production and machine maintenance.

To meet this need, various solutions have been proposed. Most commonly, operator-observing actions are carried out periodically, on teams of operators specifically dedicated to process optimization. The observations are made by observers, who retranscribe them manually in the form of spaghetti diagrams.

However, it appears that these actions of observing processes are expensive and that they cause an obvious bias in the evaluation since the behaviour of a person is different when he or she knows that he or she is being observed. Furthermore, the data are only approximate, have little granularity, and are difficult to reproduce and compare over time. The data collected therefore does not allow a reliable and objective analysis of behaviour.

Moreover, the absence of detailed analysis of the behaviour and movements of operators within a factory prevents the fatigue and mental load being borne by operators from being evaluated. Specifically, during the day they are greatly stressed in a non-linear manner, for example during peaks in activity related to the loading of machines or to malfunctions, or due to long travelled distances.

The present invention aims to remedy these drawbacks by providing a method for evaluating operators in a production workshop that meets all of the aforementioned needs.

### BRIEF DESCRIPTION OF THE INVENTION

Thus, the invention relates to a method for evaluating the path of an operator equipped with a magneto-inertial device in an industrial manufacturing workshop, the method comprising the following steps:
a step of recording measurements taken by at least one inertial and/or magnetic sensor installed in the magneto-inertial device,
a step of transmitting the measurements to a remote server,
a step of computing, on the remote server, a path of the operator depending on the measurements, and
a step of adjusting the computed path.

The paths are advantageously computed on the basis of measurements taken by at least one magnetic sensor and at least one inertial sensor, which allow, directly or indirectly, the following parameters to be determined: angles of roll, pitch, and yaw (heading) of the system; speed of movement; relative movement.

However, it has been observed that the paths determined solely from the magneto-inertial recordings drift over time with respect to the real path. This drift is explained by errors characterized in particular in heading, but also in distance. Therefore, the invention proposes a step of adjusting the computed path in order to correct these determination errors.

Preferably, the magneto-inertial device comprises at least one magnetic sensor and at least one inertial sensor. Such a device will be described in more detail below.

In one exemplary embodiment, a method according to the invention comprises a step, prior to the step of transmitting the data, of compressing said data. This allows the size of the data to be transmitted to be decreased, and therefore the system architecture required to implement such a method to be lightened.

In a first exemplary embodiment, the adjusting step is a step of adjusting a path via radiofrequency terminals, which comprises the following steps:
during the measurement-recording step, the connected device records identification information originating from radiofrequency devices installed in the workshop,
the identification information is transmitted at the same time as the measurement data,
the computed path is modified on the basis of the location of the identified radiofrequency terminals.

Advantageously, this step of radiofrequency adjusting comprises a step of interrogating a database associating radiofrequency terminal identification information with a location of these terminals. Thus, from the identification of the radiofrequency terminals it is possible to determine their location, this indicating that the operator has passed close to this location, and allowing the path to then be deformed so that it passes through these points.

The radiofrequency terminals are, for example, RFID chips or devices using BlueTooth technology or BlueTooth Low Energy technology. These terminals are preferably installed in various locations around the workshop in which a method according to the invention is intended to be implemented. The locations are chosen depending on characteristic points of passage of operators, which points are known to the managers of the workshop, and their location is stored in a database.

The choice of this type of technology for the radiofrequency terminals is in particular guided by the need for the devices to have a small bulk, but also by power supply and service life considerations. Preferably, the terminals have an adhesive backing which allows easy positioning in various locations.

The location of the radiofrequency terminals will advantageously be chosen so as to ensure operators pass regularly. Thus, for example, it is possible to choose to install the terminals on the control consoles of industrial machines, since operators must regularly approach these consoles to correctly control the machine.

Furthermore, the radiofrequency terminals will preferably be chosen so as to meet one or more criteria among the following, especially in light of the type of workshop hosting the invention:
the radio range of the adjustment of the terminals is comprised between 50 cm and 1 metre,
the precision is about 10 centimetres, and at most 50 centimetres,
the power supply life of the adjusting terminals is comprised between one week and one month.

In a second exemplary embodiment, the method is such that the adjusting step comprises a cartographic adjusting step. Various methods allowing cartographic adjustment to be performed are known in the prior art.

The type of adjustment and the techniques used depend on the space in which movement is permitted and on the nature (absolute or dead reckoning) of the positioning solution. Thus, in the case of a movement of a vehicle equipped with a GPS receiver, a means for determining the absolute position of the vehicle is available, this decreasing the risks of error in the determination of the path.

In the same way, when a vehicle is travelling through an area that has already been mapped, it is easy to adjust the path so that it corresponds to an existing road. In this case, it is possible to accept a larger measurement error, since it is only a question, to determine the path of the vehicle, of determining on which already existing route the vehicle is located. Even in the event of an error at an intersection, it is easy to adjust the path after a little time.

In contrast, in the case of a workshop, the space is much more open, where the pedestrian paths are not necessarily marked. It is therefore advisable, when they are available, to use building-related constraints to decrease the region of uncertainty.

Thus, in a method according to the invention, a plan of the workshop in which the operator moves will be used to carry out a cartographic adjustment, and the adjusting step then consists in determining a path which respects both the plan of the workshop and the ranges of uncertainty in the measurements carried out.

To this end, in one exemplary embodiment, a particle filter is employed, this consisting in distributing the uncertainty in the path between a set of particles, which vary independently and which each contain one possible state of the system. Every particle that follows an impossible path is eliminated. When the number of particles becomes too low, resampling is carried out based on the remaining particles. The new path estimate then consists in the average of the positions of the “surviving” particles. Except in special cases, this average follows a valid path and respects the uncertainty range set at the start.

A plurality of quite distinct paths may sometimes be used by various groups of particles. In order to discriminate between them, a classifying step is carried out at regular intervals. When an isolated cloud is detected the size of which is smaller than a predefined threshold, all of the corresponding particles are eliminated. A plurality of isolated particle clouds may sometimes follow separate paths, all of which are valid. In order to quickly eliminate paths that are too improbable, it is decided to eliminate isolated point clouds of small size. An isolated cloud is identified as a set of particles the smallest distance of which to all of the other particles exceeds a predefined threshold. This step is not performed on each iteration, because it involves a high number of operations (proportional to the square of the number of particles).

The possibility is reserved of taking two types of averages for the new path estimate:
the first is taken in a causal way, based at any given time on the current state of the cloud of particles. This method could be used for estimation of position in real time for a context of subsequent use.
the second is taken taking into account the variation in the cloud of particles over the entire path, and considering only particles that remain valid to the end (or the particles from which they are obtained during resampling).

In another exemplary embodiment, the implemented particle filtering must also allow a path to be corrected in a plan incorporating various levels, as is the case in certain workshops. To this end, it is useful for knowledge of the plan of the workshop to include knowledge of the positions and orientations of the approaches to the various means of changing floors, as well as their destinations (footbridge, stairs to a feed point, etc.).

In this case, it is also useful for the measurements taken by the connected device to comprise a measurement of the altitude of the wearer. This altitude measurement allows, in the implementation of the particle filter, particles located on a wrong level to be eliminated. A height-adjusting step, consisting in detecting times at which the floor on which the wearer is located can be detected with certainty, and in eliminating particles accordingly, will therefore be to be provided.

Thus, it appears that use of a particle filter is particularly advantageous as it allows drift to be limited using the constraints imposed by the building of the factory on the path followed. Furthermore, it does not require too much preliminary work, since all that is required are the plans of the workshop, it not being necessary to generate a complete mesh of the workshop, as is the case with other cartographic adjustment techniques.

Different map levels may be used:
exterior walls only when only the factory footprint is available,
complete plan with partitions, the spaces used by machines,
plan on various floors with identification of the means of passing from one floor to another.
Furthermore, it is possible to use maps enriched by identifying unlikely areas of approach, which areas could be modelled by assigning low but non-zero probabilities of passage, just as for the walls.

This technique of cartographic adjustment to achieve path correction thus has the following advantages:
A very generic definition of transitions, which include passages, doors, walls, stairs, walkways leading to one or more levels, and obstacles of all types. The algorithm is therefore simplified, and allows a path on several levels to be estimated without any altitude information, i.e. based solely on the horizontal component of the path.
A classification of the transitions depending on the floors to which they belong, this allowing processing time to be significantly decreased with respect to the case where the possibility of each path needs to be evaluated with respect to all the obstacles of the plan. This method is robust with respect to uncertainties in the positioning of the elements (positions of doors with respect to the corresponding walls, or of floors with respect to neighbouring floors). It is the average distance on the path of a particle between two times (to be parametrized by the user depending on the case) that determines the precision required for the plan. More precisely, this average distance must be located between the distance corresponding to inaccuracies in the plan and the characteristic distance of the obstacles of the plan.
This method makes it possible, when a transition element is located at the intersection between two floors (e.g. wall of a region), to assign it to either of these two floors.
This method ensures the validity of the path for a particle encountering a plurality of transitions on a plurality of floors between two times.

In one particularly advantageous exemplary embodiment, the adjusting step will comprise a first step of adjusting via radiofrequency terminals, and a second step of cartographic adjustment. Thus, the adjusting step advantageously comprises two sub-steps:
A step of preprocessing the path of the operator, in which step the path resulting from the computation is modified depending on the detection of radiofrequency terminals. In this preprocessing, the path is deformed so that points identified as close to a radiofrequency terminal are actually found close thereto. The deformation of the segment between two different terminals may take into account the uncertainty estimated by the path computation.
A step of applying a particle filter to the modified path.

By virtue of the preprocessing, the path may on the whole already be positioned and oriented on the building plan. Heading drifts are limited to the paths between two terminals. For long journeys that occasionally pass beside different terminals, the accumulation of a substantial heading error may therefore be avoided.

The extension of the particle filter allows the cloud of particles to be decreased, this reflecting the certainty in the closeness of the terminal.

The invention also relates to a system allowing a method according to the invention to be implemented, the system comprising one or more elements among:
A connected device, for example a connected bracelet, an example of which will be described below. The device advantageously comprises one or more of the following elements:
   magnetic and inertial sensors,
   an on-board computational software package,
   a radio module for detecting signals output from the radiofrequency terminals,
   a power supply, and
   preferably a barometer/altimeter,
radiofrequency terminals installed in specific locations in the workshop. For example, it will be decided to install these terminals on the control consoles of machines in front of which the user is often present,
a remote computational server comprising the software means for calculating paths from raw data and adjustment elements (radiofrequency terminals; vector map of the site, documented with prohibited regions).

In one advantageous embodiment, the system furthermore comprises a remote application server equipped with means for displaying the computed data in order to enable exploitation by a manager of the workshop.

### BRIEF DESCRIPTION OF THE FIGURES

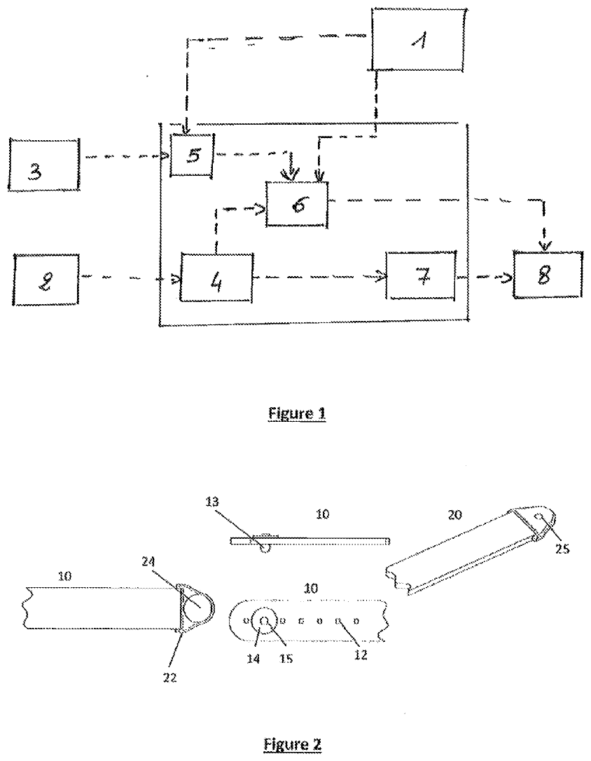

Other objectives and advantages of the invention will become clearly apparent from the following description of a preferred but non-limiting embodiment, illustrated in FIG. 1, which shows a system according to the invention, and in FIG. 2, which shows an example of a connected bracelet.

### DESCRIPTION OF THE BEST EMBODIMENT OF THE INVENTION

In one preferred embodiment, a system according to the invention is implemented in a workshop or a factory comprising a plurality of machines for assembling tyres.

With reference to FIG. 1, an example of logical architecture of a system allowing a method according to the invention to be implemented will now be described.

Three input elements are required to determine a position 8 of an operator in a workshop:
A modelled map 1 of the workshop or factory, comprising
   the constraints (walls, machines, forbidden passages, etc.)
   the means of changing floors (position on each level, approximate relative height)
A starting point 2 provided by the user. This point will comprise both the level, the 2D position and the direction of advance of the first metres. It will possibly also be delivered to the system en route, with a view to adjusting the latter if necessary. All of the adjustment points will be stored; they will possibly be used to divide the path into pieces with a view to applying a straightener in deferred time.
Measurements obtained from connected devices 3 carried by one or more operators working on one of the machines, namely, vertical speed—or position—on the one hand and horizontal speed—or position—on the other hand. Attitude may also be uploaded if it is relevant, for example if the workshop is located on several levels.

An initializing step 4 (carried out at start-up, but also possibly at any time to reset the filter) will take as input the horizontal position, level and direction in which advancement begins, these inputs being provided by the user.

A filter 5 for detecting a change of floor will work, for each particle, with the means for changing floor that is closest to it from its position. As soon as the beginning of a change of floor is detected (which a priori will happen simultaneously in a large set of particles), the constraint is integrated into the weighting 6 of the particles.

Two elements will be incorporated to modify the weighting of the particles following the propagation: changes of floor and the walls:
If a particle begins to change floors when it is not beside or on a means for changing floors (staircase, walkway, etc.), it means that there is little chance of it actually being at the location indicated thereby.
The second element used for the weighting will be whether a wall or machines have been passed through, indicating that the particle is, again, not in the correct position.

Optionally, resampling 7 will also be used to match the number of particles used to the available computing power and to the time allocated to the processing.

FIG. 2 shows an example of a bracelet for a portable device advantageously implemented in the present invention. More precisely, FIG. 2 shows the two elements 10 and 20 of a bracelet, each element being shown from two different viewpoints.

The portable device has a touch-sensitive display screen (not shown in the figure) intended to display incoming alerts, and a bracelet allowing attachment to the wrist of an operator.

This bracelet has a secure clasp, which makes it possible to guarantee that the device is held in position in normal use, but which allows the wrist to be released should the bracelet become ensnared. Specifically, such a device is intended to be used near dangerous industrial machinery. It is therefore useful to make provision for the clasp to open when, for example, the bracelet is caught by an element of the industrial machine, in order to avoid injury to the operator wearing the bracelet.

To this end, the clasp comprises two parts, each of the parts being intended to be attached to one strap of the bracelet. Thus, each part comprises mechanical fastening means for connecting it to the corresponding bracelet strap, and magnetic joining means. The magnetic means for joining the first and second parts are intended to interact.

In the example shown in FIG. 2, the first part is intended to be inserted into an orifice in the first bracelet strap. This first strap contains a plurality of orifices 12 allowing the size of the bracelet to be changed. Thus, this first part comprises an axle having at a first end a ball 13 intended to be inserted into the orifice of the bracelet. The diameter of the ball is chosen so that it is possible to voluntarily insert the first part into an orifice of the bracelet, but so that it is impossible for it to become unintentionally removed. At the other end of the axle is a circular metal plate 14, comprising a stud 15 at its centre.

The second part also comprises a circular magnetic plate 24, at the centre of which is formed a circular recess 25 that is intended to receive the stud of the first part. The magnetic and metal character of the two plates allows the two parts to be fastened when they are in contact. The stud 15 and the recess 25 make it possible to avoid lateral sliding of one part relative to the other.

The magnetic plate is installed on a holder 22 comprising an axle intended to be inserted into an end having a preformed orifice. The shape of the holder is advantageously chosen so that it does not protrude, or only slightly, laterally from the bracelet after closing.

The characteristics of the plates of the first and second parts are chosen so as to allow a release when a substantial force is exerted on the bracelet. Preferably, the magnetic elements will be chosen so that they release when a lateral force comprised between 15 N and 40 N is exerted. By lateral force, what is meant is a force exerted in a direction substantially parallel to the length of the bracelet, and not a force exerted normal to the bracelet.

1.-10. (canceled)

11. A method for evaluating the path of an operator equipped with a magneto-inertial device in an industrial manufacturing workshop, the method comprising the following steps:
recording measurements taken by at least one inertial and/or magnetic sensor installed in the magneto-inertial device
transmitting the measurements to a remote server;
computing, on the remote server, a path of the operator depending on the measurements; and
adjusting the computed path.

12. The method according to claim 11, further comprising a step, prior to the transmitting step, of compressing data comprising the measurements.

13. The method according to claim 11, wherein the adjusting step comprises adjusting the computed path via radiofrequency terminals.

14. The method according to claim 13, wherein the adjusting step comprises the following steps:
during the recording step, recording identification information originating from radiofrequency terminals installed in the workshop;
transmitting the identification information at the same time as the measurements; and
modifying the computed path on the basis of location of the identified radiofrequency terminals.

15. The method according to claim 11, wherein the adjusting step comprises a cartographic adjusting step.

16. The method according to claim 11, wherein the adjusting step comprises, prior to a cartographic adjusting step, adjusting via radiofrequency terminals.

17. A system allowing a method according to claim 11 to be implemented, the system comprising:
a connected magneto-inertial device comprising measuring means and radio means for transmitting the measurements;
radiofrequency terminals installed in specific locations in the workshop; and
a remote computational server comprising software means for computing paths from measurements and adjustments.

18. The system according to claim 17, wherein the connected magneto-inertial device comprises one or more selected from magnetic and inertial sensors, an on-board computational software package, a radio module for detecting signals output from the radiofrequency terminals, a power supply, a barometer and an altimeter.

19. The system according to claim 17, further comprising a database associating radiofrequency terminal identification information with terminal location.

20. The system according to claim 17, further comprising a remote application server equipped with means for displaying the computed paths.
